(19) United States
(12) Patent Application Publication
(10) Pub. No.: US 2010/0261452 A1
(43) Pub. Date: Oct. 14, 2010

(54) AUTHENTICATION FEDERATION SYSTEM, AUTHENTICATION FEDERATION METHOD, MOBILE TERMINAL, RELAY TERMINAL DEVICE AND SERVICE DEVICE

(75) Inventors: Katsuyuki UMEZAWA, Machida (JP); Akira Kanehira, Tokyo (JP); Kenya Nishiki, Chigasaki (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/706,508

(22) Filed: Feb. 16, 2010

(30) Foreign Application Priority Data
Apr. 13, 2009 (JP) 2009-097293

(51) Int. Cl. H04M 1/66

(52) U.S. Cl. 455/411

(57) ABSTRACT

A coupling authentication of a mobile phone terminal is performed between the mobile phone terminal and an authentication server. Both the mobile phone terminal and an authentication server store therein coupling authentication information. In performing an authentication at a service device, the mobile phone terminal generates service authentication information using coupling authentication information and transmits the generated service authentication information to the authentication server. The authentication server performs the authentication using the coupling authentication information and the service authentication information and transmits a result of a service authentication to the service device. The service device determines whether or not the service authentication has been successfully completed, based on the service authentication result.

### CROSS REFERENCE TO RELATED APPLICATIONS

This application claims the benefit of Japanese Patent Application No. 2009-097293 filed on Apr. 13, 2009, the disclosure of which is incorporated herein by reference.

### BACKGROUND

The present invention relates to an authentication technique using a mobile terminal carried by a user.

Various types of relay terminal devices such as a digital television and a personal computer have been produced on a commercial basis these years. The relay terminal device is coupled to a fixed network and makes it possible to enjoy a large-capacity broadband communication service (to be referred to as a communication service or a service hereinafter) on a large-sized screen. The relay terminal device receives a communication service from a center apparatus which provides the communication service and outputs a picture image or the like on its display unit. If a user wishes to enjoy such a communication service, the center apparatus performs an authentication processing of the user or the relay terminal device for charging a fee. The relay terminal device also performs an authentication processing of the user.

For example, “Generic Authentication Architecture (GAA), 3GPP TS 33.220 3rd Generation Partnership Project (to be referred to as Non-patent Document 1 hereinafter)” discloses an authentication between a terminal and a center apparatus. Non-patent Document 1 describes that, for the purpose of enjoying a communication service, a mobile phone terminal is used to perform an authentication processing with a center apparatus, and, if the mobile phone terminal has succeeded in the authentication, the mobile phone terminal receives the communication service.

### SUMMARY

If a function of the relay terminal device of performing an authentication processing is simplified, cost can be effectively reduced, because, as described above, there are a wide variety of different specifications in the relay terminal devices. Further, if a function of the center apparatus of performing an authentication processing is simplified, load of processing communication services on the center apparatus can be effectively reduced.

In particular, in simplifying an authentication processing of the relay terminal device, it is highly convenient for a user to perform an authentication using a mobile terminal (for example, a mobile phone terminal, a personal digital assistance, and a laptop personal computer) which has been widely used and can be easily carried by the user. That is, it is advantageous to use a mobile terminal in performing an authentication of both a user and a relay terminal device. In simplifying an authentication processing of the center apparatus, it is at least necessary that a user who has received a communication service via a relay terminal device located at one site continues to receive the same communication service via another relay terminal device located at another site to which the user travels. This case is hereinafter referred to as handover. Non-patent Document 1 teaches an authentication method of a mobile phone terminal, however, does not teach simplified authentication processings of the relay terminal device and the center apparatus.

The disclosed system provides simplified authentication processings of a relay terminal device and a center apparatus.

An authentication federation system includes: a center apparatus (which may also be referred to as a service device) that provides a communication service; a relay terminal device that a user uses for enjoying the communication service; and an authentication server that performs an authentication. The center apparatus, the relay terminal device, and the authentication server are communicably coupled to a fixed network, and an authentication is performed by a mobile terminal (which may also be referred to as a mobile phone terminal) carried by the user via the relay terminal device. The authentication federation system includes steps as follows.

The mobile terminal and the authentication server perform an authentication processing therebetween and generate first authentication information. Each of the authentication server and the mobile terminal stores therein the first authentication information. The mobile terminal generates second authentication information using service information received from the relay terminal device and the first authentication information, stores therein the second authentication information, and transmits the second authentication information to the authentication server via the relay terminal device and the center apparatus. The authentication server performs an authentication processing using the received second authentication information and the first authentication information and transmits a result of the authentication processing to the center apparatus. The center apparatus makes a determination on the received authentication processing result, and, if the authentication processing result indicates that the authentication has been successfully completed, provides the service to the relay terminal device.

According to the teaching herein, simplified authentication processings of the center apparatus and the relay terminal device can be provided.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1A to FIG. 1C are diagrams each illustrating an outline of an authentication processing according to an embodiment of the present invention. FIG. 1A is a diagram illustrating an authentication at an initial stage (which may also be referred to as Case A). FIG. 1B a diagram illustrating an authentication at handover (which may also be referred to as Case B). FIG. 1C is a diagram illustrating another authentication at handover (which may also be referred to as Case C).

FIG. 2 is a diagram illustrating a configuration example of an authentication federation system according to the embodiment.

FIG. 3A to FIG. 3D are diagrams each illustrating an example of internal functions of the device constituting the authentication federation system. FIG. 3A is a diagram illustrating a function of a mobile phone terminal. FIG. 3B is a diagram illustrating a function of a relay terminal device. FIG. 3C is a diagram illustrating a function of an authentication server. FIG. 3D is a diagram illustrating a function of a service device.

FIG. 4 is a diagram illustrating internal configurations of the devices constituting the authentication federation system.

FIG. 5 is a diagram illustrating a flow of a coupling authentication processing according to the embodiment.

FIG. 6 is a diagram illustrating a flow of a service authentication processing according to the embodiment.

FIG. 7 is a diagram illustrating a flow of a processing of a service authentication according to the embodiment.

### DETAILED DESCRIPTION OF THE EXEMPLARY EMBODIMENT

Next is described in detail an embodiment for carrying out the present invention, in which a mobile phone terminal is used as a mobile terminal, with reference to related drawings.

### <<Outline>>

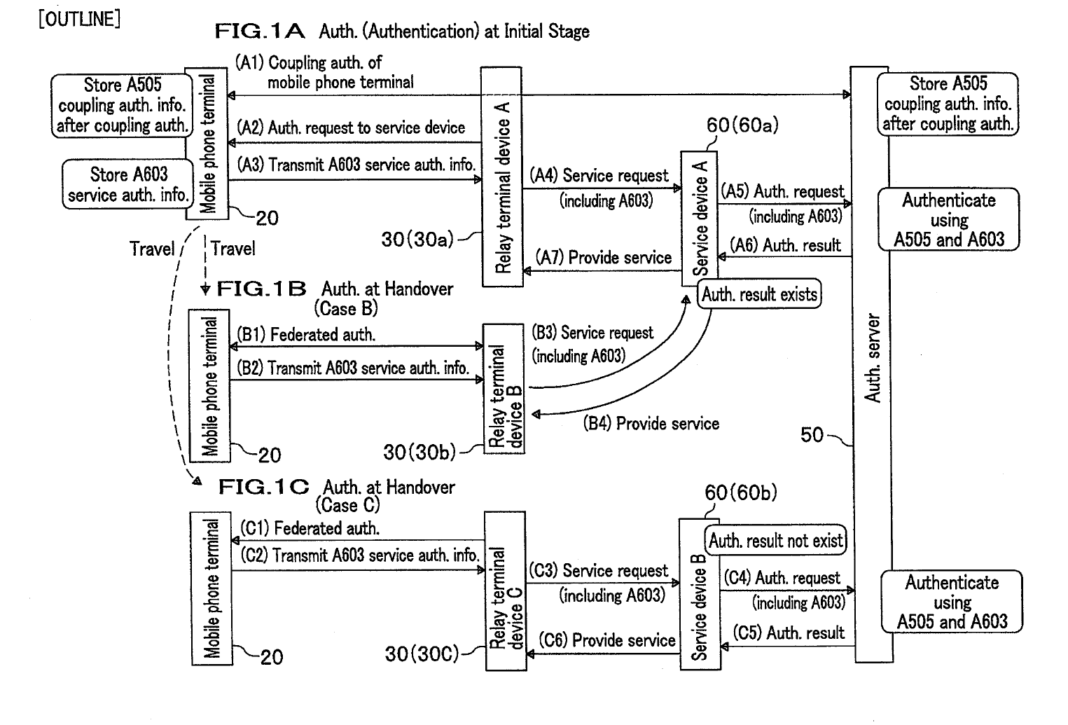

An outline of an authentication processing according to the embodiment is described with reference to FIG. 1. In a configuration of performing an authentication processing according to this embodiment, a mobile phone terminal 20 as a mobile terminal performs an authentication via a relay terminal device 30 (which collectively refers to relay terminal devices 30a, 30b, 30c) disposed at a terminal of a fixed network. In addition to the relay terminal device 30, a service device 60 (which collectively refers to service devices 60a, 60b) which provides a service and an authentication server 50 which performs an authentication are also coupled to the fixed network. The relay terminal device 30 is embodied by, for example, a digital television (IPTV: Internet Protocol TeleVision) a PC (Personal Computer, or the like. The service device is the center apparatus as described above.

FIG. 1A illustrates an outline of an authentication at an initial stage (which may also be referred to as Case A). More specifically, in Case A, an authentication has not yet been performed between the mobile phone terminal 20 and the authentication server 50. For example, assume that you subscribe a communication service (which may be simply referred to as a service hereinafter) or apply for a service. The application may be on a specified-time, hourly, daily, day-of-the-week, weekly, monthly, or yearly basis. First, a coupling authentication which is an authentication for allowing a coupling is performed between the mobile phone terminal 20 and the authentication server 50 via the relay terminal device A (30a). This step is designated by a reference numeral A1 and may also be referred to as a first authentication processing. A known symmetric-key or a public-key cryptography is used in the authentication. As a result of the completed coupling authentication, coupling authentication information is generated. All or part of the coupling authentication information (at least information which allows the mobile phone terminal 20 to be coupled) is stored in the mobile phone terminal 20 and the authentication server 50 as coupling authentication information A505 (which may also be referred to as first authentication information).

Next, a relay terminal device A (30a) transmits an authentication request which is a request of an authentication to the service device 60a, to the mobile phone terminal 20. This step is designated by a reference numeral A2. The mobile phone terminal 20 generates service authentication information A603 using the coupling authentication information A505 stored therein and service information included in the authentication request to the service device 60a. The mobile phone terminal 20 transmits the generated service authentication information A603 to the relay terminal device A (30a). This step is designated by a reference numeral A3. All or part of the coupling authentication information (at least information which allows the mobile phone terminal 20 to be coupled) is stored in the mobile phone terminal 20 as service authentication information A603 (which may also be referred to as second authentication information).

Then, the relay terminal device A (30a) transmits a service request including the service authentication information A603 to the service device A (60a). This step is designated by a reference numeral A4. The service device A (60a) transmits the authentication request including the service authentication information A603 to the authentication server 50. This step is designated by a reference numeral A5. The authentication server 50 performs an authentication using the received service authentication information A603 and the coupling authentication information A505 (which may also be referred to as a second authentication processing), to thereby generate a service authentication result (which may also be referred to as a result of the second authentication processing). Then, the authentication server 50 transmits the service authentication result to the service device A (60a). This step is designated by a reference numeral A6. The service device A (60a) determines whether or not the authentication has been successfully completed, based on the received service authentication result. If the authentication is determined to have been successfully completed, the service device A (60a) provides the service. This step is designated by a reference numeral A7. Further, the service device A (60a) stores therein the service authentication result.

As described above, the authentication processing of Case A shown in FIG. 1A is performed only at the mobile phone terminal 20 and the authentication server 50. This means that the authentication processing performed at the relay terminal device A (30a) and the service device A (60a) can be simplified.

FIG. 1B is a diagram illustrating an authentication at handover (which may also be referred to as Case B) in which the mobile phone terminal 20 travels and then receives a service from the service device A (60a) via a relay terminal device B (30b) located in a destination of the mobile phone terminal 20. First, the mobile phone terminal 20 receives federated authentication information (which may also be referred to as third authentication information) from the relay terminal device B (30b) and performs a federated authentication (which may also be referred to as a third authentication processing). This step is designated by a reference numeral B1. If the federated authentication has been successfully performed, the mobile phone terminal 20 transmits the stored service authentication information A603 to the relay terminal device B (30b). This step is designated by a reference numeral B2. The relay terminal device B (30b) transmits a service request including the service authentication information A603 to the service device A (60a). This step is designated by a reference numeral B3. The service device A (60a) retrieves the already-stored service authentication result on the service authentication information A603, and, if the authentication has been successfully completed, the service device A (60a) provides the service. This step is designated by a reference numeral B4. Note that, if the service device A (60a) determines that the service authentication result has not been stored therein, the service device A (60a) does not provide the service.

As described above, in Case B shown in FIG. 1B, the authentication processing at handover can also be simplified, because the service device A (60a) just determines, based on the authentication results which have already been stored therein, whether or not the authentication concerning the service authentication information A603 received from the relay terminal device B (30b) in step B3 has been successfully completed. Moreover, an authentication of the relay terminal device B (30b) to be performed by the service device A (60a) can be omitted, because, instead of the service device A (60a), the mobile phone terminal 20 which has already been authenticated performs the authentication of the relay terminal device B (30b) through the federated authentication.

FIG. 1C is a diagram illustrating an outline of another authentication at handover (which may also be referred to as Case C) in which the mobile phone terminal 20 travels and then receives a service from the service device B (60b) via the relay terminal device C (30c) located in a destination of the mobile phone terminal 20. First, the mobile phone terminal 20 receives federated authentication information from the relay terminal device C (30c) and performs a federated authentication. This step is designated by a reference numeral C1. If the federated authentication has been successfully performed, the mobile phone terminal 20 transmits the service authentication information A603 which has been generated after A2 and has been stored therein, to the relay terminal device C (30c). This step is designated by a reference numeral C2. The relay terminal device C (30c) transmits a service request including the service authentication information A603 to the service device B (60b). This step is designated by a reference numeral C3. The service device B (60b) retrieves the service authentication result on the service authentication information A603 received from the mobile phone terminal 20 via the relay terminal device C (30c). If the service device B (60b) determines that the service authentication result has not been stored therein, the service device B (60b) transmits an authentication request including the service authentication information A603 to the authentication server 50. This step is designated by a reference numeral C4. Then, the authentication server 50 performs the authentication using the service authentication information A603 and the coupling authentication information A505, to thereby generate a service authentication result. After that, the authentication server transmits the service authentication result to the service device B (60b). This step is designated by a reference numeral C5. The service device B (60b) determines whether or not the authentication has been successfully completed, based on the received service authentication result. If the service device B (60b) determines that the authentication has been successfully completed, the service device B (60b) provides the service. This step is designated by a reference numeral C6. Further, the service device B (60b) stores therein the service authentication result.

As described above, in Case C shown in FIG. 1C, the authentication processing at handover can also be simplified, because the service device B (60b) just determines, based on the authentication results which have already been stored therein, whether or not the authentication concerning the service authentication information A603 received from the relay terminal device C (30c) has been successfully completed. Moreover, an authentication of the relay terminal device C (30c) to be otherwise performed by the service device B (60b) can be omitted, because, instead of the service device B (60b), the mobile phone terminal 20 which has already been authenticated performs the authentication of the relay terminal device C (30c) through the federated authentication.

### <<Authentication Federation System>>

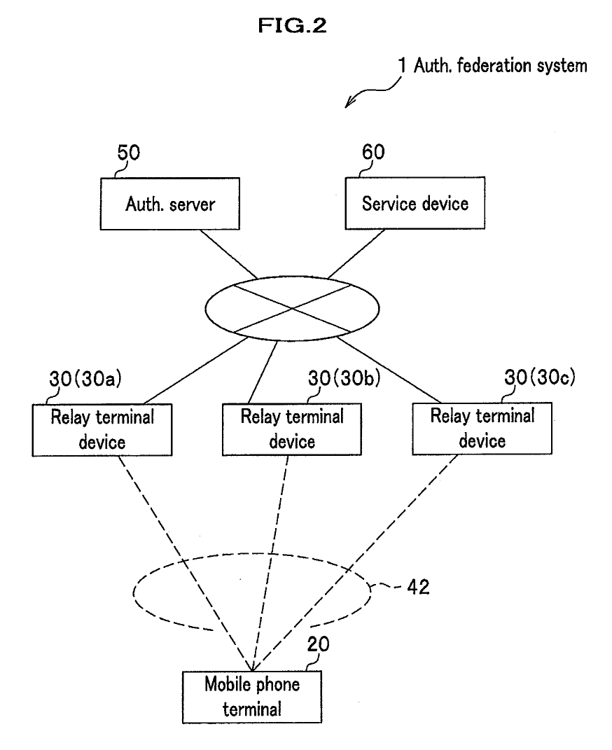

A configuration example of an authentication federation system 1 according to this embodiment is described with reference to FIG. 2. The authentication federation system 1 includes the mobile phone terminal 20, the relay terminal devices 30a, 30b, 30c, (collectively, the relay terminal device 30), the authentication server 50, and the service device 60. The devices 30, 50, and 60 are communicably coupled to each other via a network 41. The devices 20 and 30 are communicably coupled to each other via a communication route 42. The network 41 may be LAN (Local Area Network), WAN (Wide Area Network), the Internet, or the like. It is assumed herein that the communication route 42 may be either a proximity wireless communication or Bluetooth (registered trademark) according to an amount of information to be transmitted and received. However, the communication route 42 is not limited to this and may be embodied by a coupling cable such as USB (Universal Serial Bus) or a radio communication using wireless LAN or the like.

FIG. 2 illustrates only one unit of each of the mobile phone terminal 20, the authentication server 50, and the service device 60. However, the number of units of the devices 20, 50, 60 may be two or more. Further, FIG. 2 illustrates three units of the relay terminal device 30. However, the number of units thereof is not limited to this.

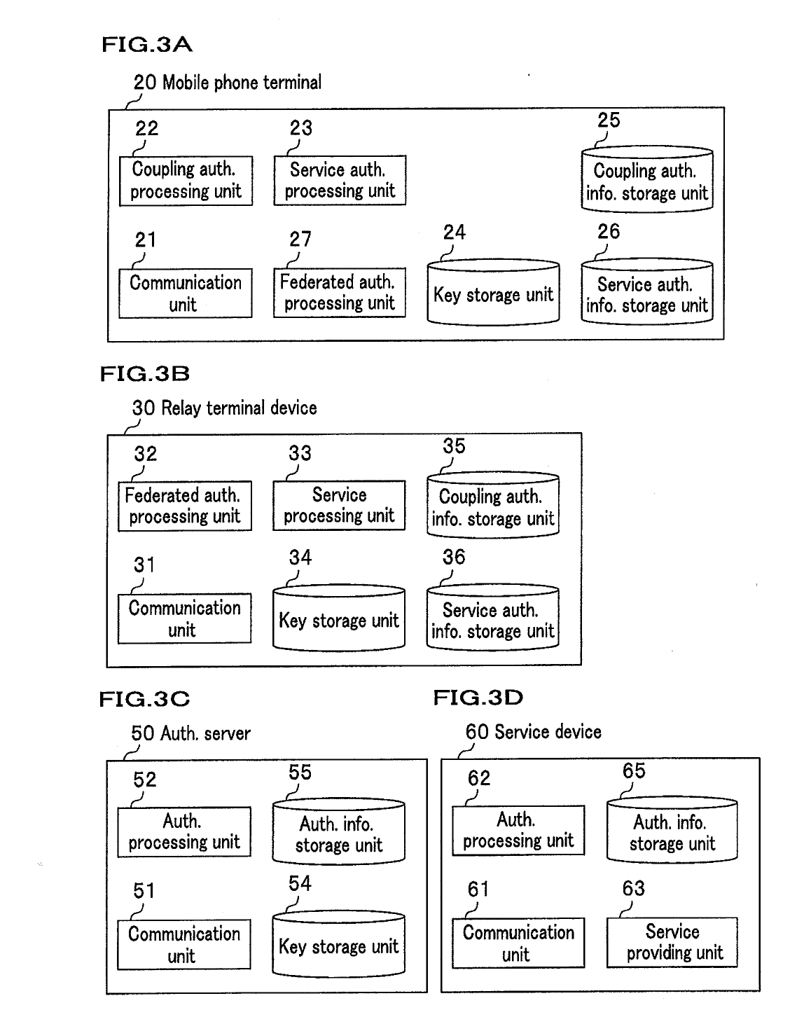

Next are described major functions of the devices 20, 30, 50, and 60 with reference to FIG. 3A to FIG. 3D. As shown in FIG. 3A, the mobile phone terminal 20 includes a communication unit 21, a coupling authentication processing unit 22, a service authentication processing unit 23, federated authentication processing unit 27, a key storage unit 24, a coupling authentication information storage unit 25, and a service authentication information storage unit 26. The communication unit 21 controls a communication via the communication route 42. The coupling authentication processing unit 22 performs step A1 of FIG. 1. The service authentication processing unit 23 performs step A3 of FIG. 1. The federated authentication processing unit 27 performs steps B1 and C1 of FIG. 1. The key storage unit 24 stores therein a key for use in a coupling authentication and a federated authentication. The coupling authentication information storage unit 25 stores therein the coupling authentication information A505 generated in the coupling authentication in step A1. The service authentication information storage unit 26 stores therein the service authentication information A603 for use in transmitting the service authentication information in step A3.

As shown in FIG. 3B, the relay terminal device 30 includes a communication unit 31, a federated authentication processing unit 32, a service processing unit 33, a key storage unit 34, a coupling authentication information storage unit 35, and a service authentication information storage unit 36. The communication unit 31 controls a communication via the network 41 and the communication route 42 shown in FIG. 2. The federated authentication processing unit 32 performs steps B1 and C1 of FIG. 1. The service processing unit 33 receives a service from the service device 60, carries out a calculation processing of data on the service, and displays the processed data on a display unit not shown. The key storage unit 34 stores therein a key used in a federated authentication. The coupling authentication information storage unit 35 stores therein the coupling authentication information A505 generated in the coupling authentication in step A1 of FIG. 1. The service authentication information storage unit 26 stores therein service information included in the authentication request to the service device 60 in step A2 of FIG. 1.

As shown in FIG. 3C, the authentication server 50 includes a communication unit 51, an authentication processing unit 52, a key storage unit 54, and an authentication information storage unit 55. The communication unit 51 controls a communication via the network 41 shown in FIG. 2. The authentication processing unit 52 performs steps A1 and A6 of FIG. 1A and C5 of FIG. 1C. The key storage unit 54 stores therein a key used in a coupling authentication. The authentication information storage unit 55 stores therein the coupling authentication information A505 generated in the coupling authentication.

As shown in FIG. 3D, the service device 60 includes a communication unit 61, an authentication processing unit 62, a service providing unit 63, and an authentication information storage unit 65. The communication unit 61 controls a communication via the network 41 shown in FIG. 2. The authentication processing unit 62 performs step AS of FIG. 1A and step C6 of FIG. 1C and determines whether or not an authentication has been successfully completed, based on a service authentication result received from the authentication server 50. The service providing unit 63 provides a service based on a result determined by the authentication processing unit 62. The authentication information storage unit 65 stores therein a service authentication result generated in a service authentication.

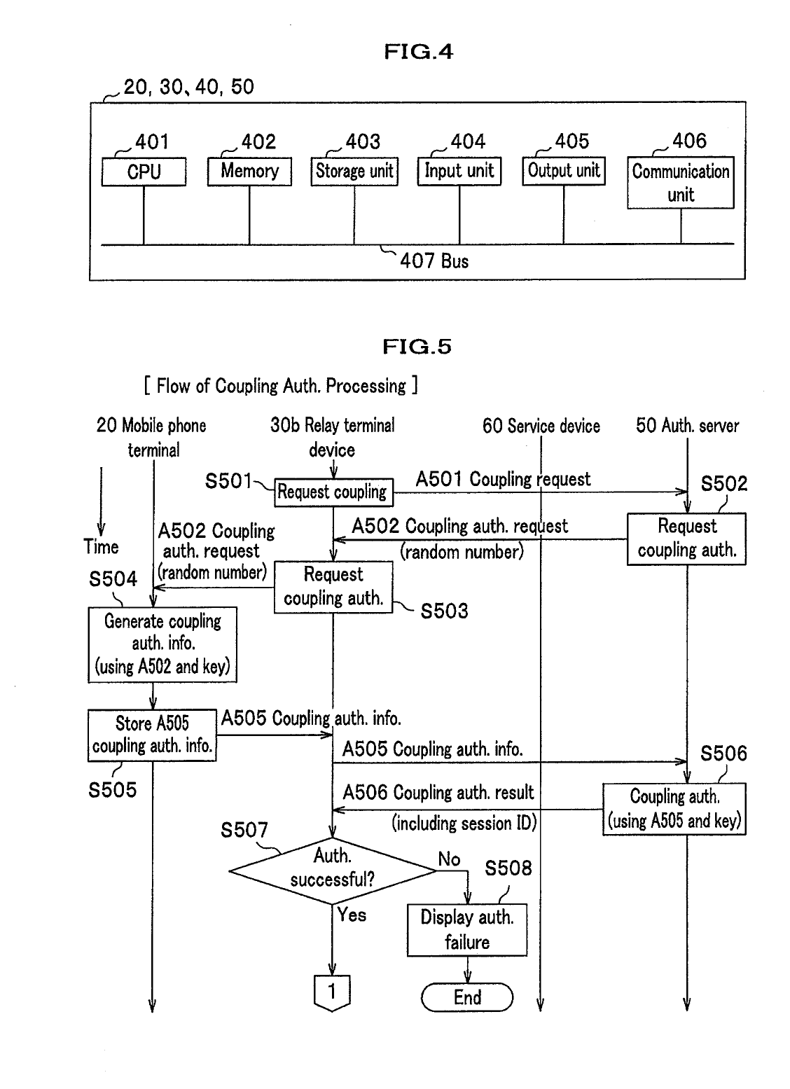

FIG. 4 illustrates an example of an internal configuration of the mobile phone terminal 20, the relay terminal device 30, the authentication server 50, and the service device 60. Each of the devices 20, 30, 50, 60 includes a CPU (Central Processing Unit) 401, a memory 402 as a main storage, a storage unit 403, an input unit 404, an output unit 405, and a communication unit 406. The CPU 401, memory 402, storage unit 403, input unit 404, output unit 405, and communication unit 406 are coupled to each other via a bus 407.

The CPU 401 is, for example, a CPU of a computer. The CPU 401 embodies a calculation processing in the devices 20, 30, 50, 60 by loading an application program in the memory 402 and executing the program. The storage unit 403 may be, for example, a storage medium such as a CD-R (Compact Disc Recordable), a DVD-RAM (Digital Versatile Disk-Random Access Memory), and a silicon disk, and a HDD (Hard Disk Drive) as a drive unit of the storage medium. The storage unit 403 stores therein various types of information used in a calculation or an application program executed in the CPU 401. The input unit 404 is, for example, a keyboard, a mouse, a scanner, and a microphone. The output unit 405 is, for example, a display unit, a speaker, and a printer. The communication unit 406 functions as the communication units 21, 31, 51, 61 of the respective devices 20, 30, 50, 60.

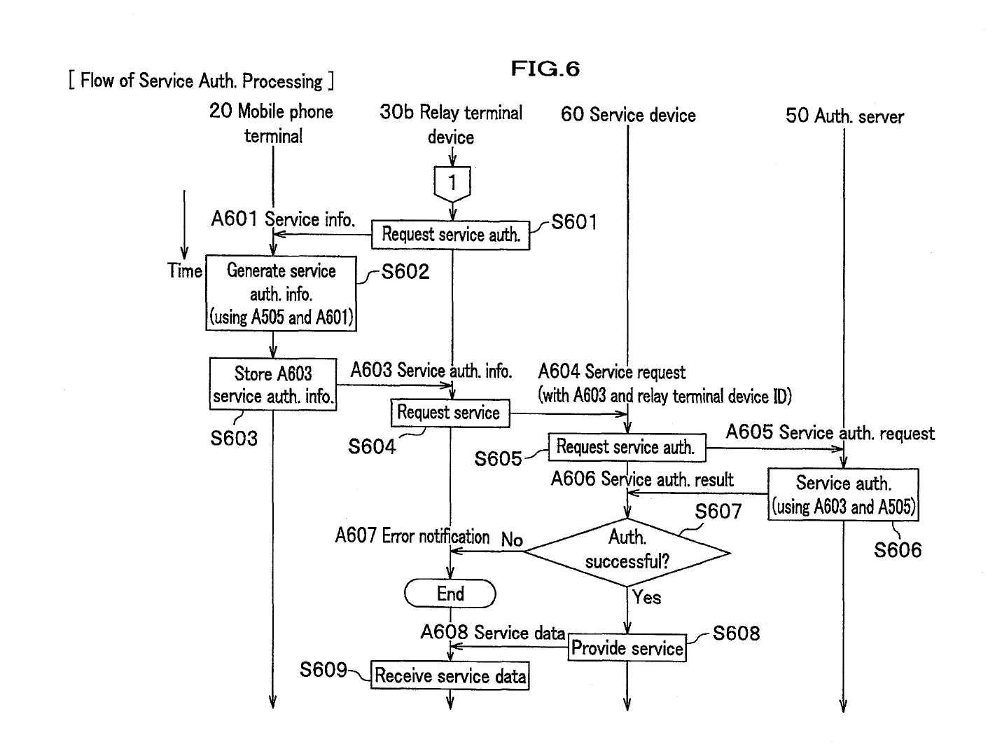

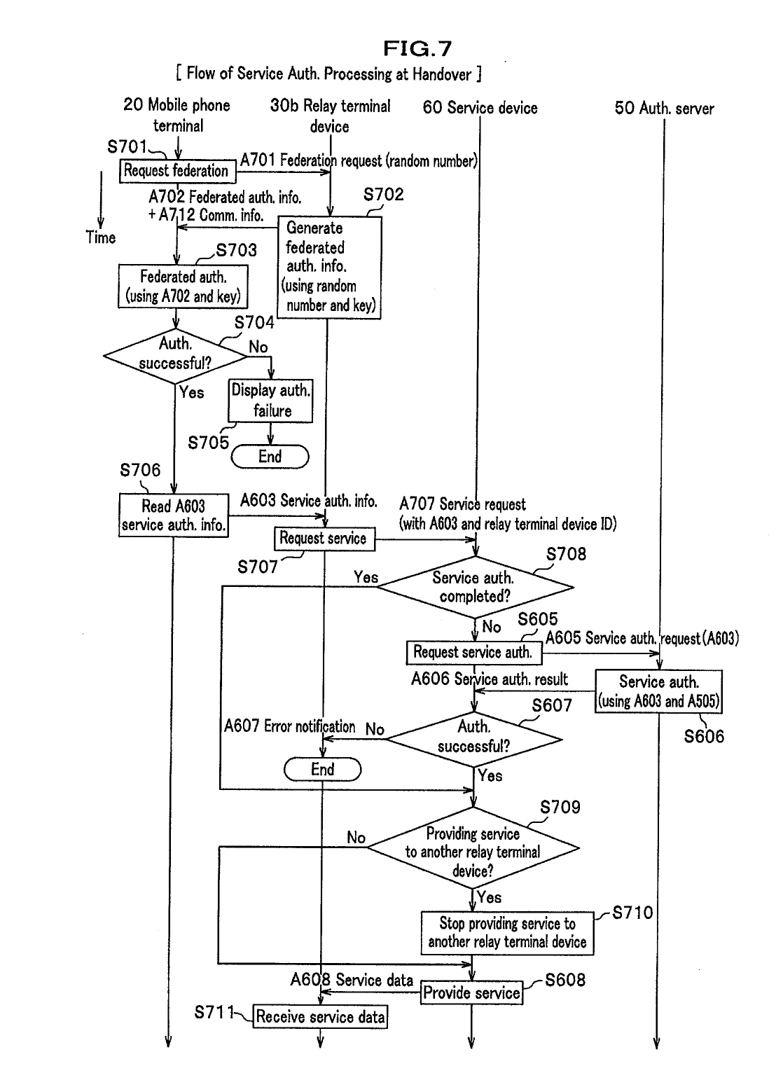

Next are described flows of processings in this embodiment with reference to FIG. 5 to FIG. 7. FIG. 5 illustrates a flow of a coupling authentication processing. FIG. 6 illustrates a flow of a service authentication processing. FIG. 7 illustrates a flow of a federated processing and a subsequent service processing. FIG. 5 corresponds to the processing of Case A of FIG. 1A. FIG. 6 corresponds to the processing of Case B of FIG. 1B. FIG. 7 corresponds to the processing of Case C of FIG. 1C. Note that description of the processings in FIG. 5 to FIG. 7 is made assuming that the symmetric-key cryptography is used.

### <<Coupling Authentication Processing>>

As shown in FIG. 5, in step S501, the relay terminal device 30a transmits a coupling request A501 to the authentication server 50. Step S501 is carried out, if the relay terminal device 30a is a digital television, when the television is turned on, or, if the relay terminal device 30a is a personal computer, when a browser or a dedicated application for receiving a service of interest is started. In step S502, the authentication server 50 transmits in turn a coupling authentication request A502 to the relay terminal device 30a. The coupling authentication request A502 contains at least information used in the authentication (for example, a random number).

In step S503, the relay terminal device 30a transfers the received coupling authentication request A502 to the mobile phone terminal 20. Instep S504, the mobile phone terminal 20 generates coupling authentication information using the received coupling authentication request A502 and a key for the coupling authentication stored in the key storage unit 24. In step S505, the mobile phone terminal 20 stores all or part (at least a part that allows the authentication) of the generated coupling authentication information as the coupling authentication information A505 (the first authentication information), in the coupling authentication information storage unit 25. Further, the mobile phone terminal 20 transmits the coupling authentication information A505 to the relay terminal device 30a. The relay terminal device 30a transfers the received coupling authentication information A505 to the authentication server 50.

In step S506, the authentication server 50 carries out the coupling authentication using the received coupling authentication information A505 and the key for the coupling authentication stored in the key storage unit 54. The authentication server 50 transmits a coupling authentication result A506 (that is, a result of the first authentication processing) to the relay terminal device 30a. Besides the authentication result, the coupling authentication result A506 includes at least, for example, a session ID for identifying a session assuming that a series of steps from step S501 to S506 is one session. In step S507, the relay terminal device 30a determines whether or not the authentication has been successfully completed, based on the received coupling authentication result A506. If the relay terminal device 30a determines that the authentication has not been successfully completed (if No in step S507), in step S508, the relay terminal device 30a displays that the authentication has failed in the output unit 405 (see FIG. 4) and terminates the processing. If the relay terminal device 30a determines that the authentication has been successfully completed (if Yes in step S507), the relay terminal device 30a proceeds to step S601 shown in FIG. 6. Note that steps S502 to S506 may also be referred to as the first authentication processing.

### <<Service Authentication Processing>>

As shown in FIG. 6, in step S601, the relay terminal device 30a carries out a service authentication request and transmits service information A601 to the mobile phone terminal 20. The service information A601 includes a service ID for identifying the service authentication processing. In step S602, the mobile phone terminal 20 generates service authentication information using the coupling authentication information A505 stored in the coupling authentication information storage unit 25 and the service information A601. In step S603, the mobile phone terminal 20 stores all or part (at least apart that allows the authentication) of the generated service authentication information as the service authentication information A603 (the second authentication information), in the service authentication information storage unit 26. The mobile phone terminal 20 transmits the service authentication information A603 to the relay terminal device 30a. Instep S604, the relay terminal device 30a transmits a service request A604 including the received service authentication information A603 and a relay terminal device ID for identifying the relay terminal device 30a itself, to the service device 60. The service device 60 stores the service authentication information A603 included in the service request A604 and the relay terminal device ID of the relay terminal device 30a, in the authentication information storage unit 65.

In step S605, the service device 60 transmits a service authentication request A605 including the service authentication information A603, to the authentication server 50. In step S606, the authentication server 50 carries out the service authentication processing (the second authentication processing) using the service authentication information A603 and the coupling authentication information A505 stored in the authentication information storage unit 55. The authentication server 50 transmits a service authentication result A606 which is a result of the service authentication processing (a result of the second authentication processing), to the service device 60.

In step S607, the service device 60 determines whether or not the authentication has been successfully completed, based on the received service authentication result A606. Further, the service device 60 stores the received service authentication result A606 in association with the service authentication information A603, in the authentication information storage unit 65. If the service device 60 determines that the authentication has failed (if No in step S607), the service device 60 transmits an error notification A607 indicating the authentication failure to the relay terminal device 30a, based on the relay terminal device ID stored in the authentication information storage unit 65. The relay terminal device 30a then terminates the processing. If the service device 60 determines that the authentication has been successfully completed (if Yes in step S607), in step S608, the service device 60 provides a prescribed service such as a transmission of a service data A608 to the relay terminal device 30a, based on the relay terminal device ID stored in the authentication information storage unit 65. In step S609, the relay terminal device 30a receives the service data A608, which allows the relay terminal device 30a to enjoy the prescribed service (for example, if the relay terminal device 30a is a digital television, contents for the digital television can be enjoyed).

### <<Service Authentication Processing at Handover>>

FIG. 7 illustrates a flow of a service authentication processing in which, if the mobile phone terminal 20 travels from one place to another and then receives a service via the relay terminal device 30b (which may also be referred to as a second relay terminal device) located in the place in which the mobile phone terminal 20 arrives after the travel. That is, FIG. 7 illustrates a service authentication processing at handover. Description of processings in FIG. 7 same as those in FIG. 6 is made using the same reference numerals.

In step S701, the mobile phone terminal 20 transmits a federation request A701 (information used for a federated authentication) to the relay terminal device 30b. The federation request A701 includes a random number. In step S702, the relay terminal device 30b generates federated authentication information using the federation request A701 and a key stored in the key storage unit 34 (which may also be referred to as a third authentication processing). The relay terminal device 30b refers to all or part (at least apart that allows the authentication) of the generated federated authentication information, as federated authentication information A702 (which may also be referred to as third authentication information). The relay terminal device 30b then transmits the federated authentication information A702 and communication information A712 to the mobile phone terminal 20. The communication information A712 is information shared by the mobile phone terminal 20 and the relay terminal device 30b so as to newly perform a communication therebetween.

In step S703, the mobile phone terminal 20 performs a federated authentication processing, using the received federated authentication information A702 and the key stored in the key storage unit 24. In step S704, the mobile phone terminal 20 determines whether or not the authentication has been successfully completed, based on a result of the federated authentication processing (which may also be referred to as a result of the third authentication processing). If the mobile phone terminal 20 determines that the authentication has failed (if No in step S704), the mobile phone terminal 20 displays the authentication failure in the output unit 405 (see FIG. 4) (step S705). The mobile phone terminal 20 then terminates the processing. If the mobile phone terminal 20 determines that the authentication has been successfully completed (if Yes in step S704), the mobile phone terminal 20 reads the service authentication information A603 stored in the service authentication information storage unit 26 in step S603 of FIG. 6 (step S706). The mobile phone terminal 20 transmits the service authentication information A603 to the relay terminal device 30b via a communication path based on the communication information A712. In step S707, the relay terminal device 30b transmits a service request A707 including the received service authentication information A603 and a relay terminal device ID for identifying the relay terminal device 30b itself, to the service device 60. The service device 60 stores the service authentication information A603 and the relay terminal device ID of the relay terminal device 30b, in the authentication information storage unit 65.

In step S708, the service device 60 determines whether or not the service authentication has already been successfully completed. To make the determination, the service device 60 retrieves information on whether or not the authentication information storage unit 65 has already stored therein the service authentication result A606 concerning the service authentication information A603. For example, the service device 60 determines that the service authentication has already been successfully completed, if the authentication information storage unit 65 has already stored therein the service authentication result A606 concerning the service authentication information A603 received from the authentication server 50.

If the service device 60 determines that the service authentication has not yet been completed (if No in step S708), in step S605, the service device 60 transmits the service authentication request A605 including the service authentication information A603, to the authentication server 50. In step S606, the authentication server 50 performs a processing of a service authentication, using the service authentication information A603 and the coupling authentication information A505 stored in the authentication information storage unit 55. The authentication server 50 transmits the service authentication result A606 which is a result of the service authentication processing, to the service device 60.

In step S607, the service device 60 determines whether or not the authentication has been successfully completed, based on the received service authentication result A606. The service device 60 stores the received service authentication result A606 in association with the service authentication information A603, in the authentication information storage unit 65. If the service device 60 determines that the authentication has failed (if No in step S607), the service device 60 transmits the error notification A607 indicating the authentication failure to the relay terminal device 30b, based on the relay terminal device ID stored in the authentication information storage unit 65. The relay terminal device 30b then terminates the processing.

If the service device 60 determines that the service authentication has already been completed (if Yes in step S708) or if the service device 60 determines that the authentication has been successfully completed (if Yes in step S607), then, in step S709, the service device 60 references the authentication information storage unit 65 using the service authentication information A603, to thereby determine whether or not the service of interest has being provided to another relay terminal device 30a. In other words, the service device 60 determines whether or not the relay terminal device ID received upon the service request A707 is identical with the relay terminal device ID received upon the service request A604 shown in FIG. 6.

If the requested service has being provided to another relay terminal device (if Yes in step S709), in step S710, the service device 60 stops providing the service to another relay terminal device (in FIG. 7, the relay terminal device 30a). If the service has not being provided to another relay terminal device (if No in step S709), the service device 60 skips step S710. In step S608, the service device 60 provides the service such as a transmission of the service data A608 to the relay terminal device 30b. In step S711, the relay terminal device 30b is provided with the service by receiving the service data A608 or the like.

In the authentication federation system 1 according to this embodiment, the mobile phone terminal 20 and the authentication server 50 store each therein the coupling authentication information A505 generated in an initial coupling authentication. If the relay terminal device 30 is provided with a service by the service device 60, the mobile phone terminal 20 generates the service authentication information A603 using the coupling authentication information A505, stores therein the service authentication information A603, and also transmits the service authentication information A603 to the authentication server 50. The authentication server 50 performs a service authentication using the coupling authentication information A505 and the service authentication information A603 and transmits the service authentication result A606 to the service device 60. The service device 60 stores therein the service authentication result A606 and determines whether or not the service authentication has been successfully completed, based on the service authentication result A606 service authentication. Thus, the authentication processing is performed only at the mobile phone terminal 20 and the authentication server 50. This means that the authentication processing at the relay terminal device 30 and the service device 60 can be simplified.

Further, at handover, a federated authentication is performed between the mobile phone terminal 20 and the relay terminal device 30. If the authentication has been successfully completed, the mobile phone terminal 20 reads the service authentication information A603 stored therein and transmits the service authentication information A603 to the service device 60. The service device 60 retrieves a service authentication result concerning the service authentication information A603 having been stored therein. If the authentication has been successfully completed, the service device 60 provides a service. Note that, if the service device 60 has not stored therein the service authentication result, the service device 60 does not provide the service. As described above, the authentication processing at handover can also be simplified, because the service device 60 just determines, based on the authentication result which has already been stored therein, whether or not the authentication concerning the service authentication information A603 has been successfully completed. Moreover, an authentication of the relay terminal device 30 to be otherwise performed by the service device 60 can be omitted, because, instead of the service device 60, the mobile phone terminal 20 which has already been authenticated performs an authentication of the relay terminal device 30 through the federated authentication.

Herein, the relay terminal device 30 includes the coupling authentication information storage unit 35 and the service authentication information storage unit 36. However, the relay terminal device 30 may obtain authentication information from the coupling authentication information storage unit 25 and the service authentication information storage unit 26 of the mobile phone terminal 20. This eliminates the use of the coupling authentication information storage unit 35 and the service authentication information storage unit 36 of the relay terminal device 30.

The processings in FIG. 5 to FIG. 7 have been described assuming that the symmetric-key cryptography is used. However, the public-key cryptography may be used. In this case, instep S506 of FIG. 5, a verification processing is performed.

In step S702 of FIG. 7, the communication information A712 is transmitted from the relay terminal device 30b to the mobile phone terminal 20, to thereby specify a coupling destination. Alternatively, instead of transmitting the communication information A712, just prior to step S706 of FIG. 7, the mobile phone terminal 20 may transmit a service request to the relay terminal device 30b, carry out steps S601 and S602 of FIG. 6, and, at this time, include information on the coupling destination in the service information A601.

In the flow of the processing of FIG. 5, the mobile phone terminal 20 maybe exchanged for the authentication server 50.

This does not change a flow of a processing performed by the relay terminal device 30a.

The specification and drawings are, accordingly, to be regarded in an illustrative rather than a restrictive sense. It will, however, be evident that various modifications and changes may be made thereto without departing from the spirit and scope of the invention as set forth in the claims.

1. An authentication federation system comprising:
a service device that provides a service via a network;
a relay terminal device that receives the service via the network;
a mobile terminal that is carried and used by a user; and
an authentication server that performs an authentication,
the authentication federation system capable of simplifying a processing of the authentication by the service device and the relay terminal device,
wherein the mobile terminal and the relay terminal device are communicable to each other, and the relay terminal device, the service device, and the authentication server are communicable to each other via the network,
wherein each of the mobile terminal and the authentication server stores therein all or part of authentication information generated in a first authentication processing which is a processing for a first authentication performed between the mobile terminal and the authentication server, as first authentication information,
wherein the relay terminal device receives a result of the first authentication processing from either the mobile terminal or the authentication server, determines whether or not the first authentication has been successfully completed based on the result of the first authentication processing, and transmits service information for use in a service authentication to the mobile phone terminal if the first authentication is determined to be successful,
wherein the mobile terminal generates service authentication information using the first authentication information and the service information, stores therein all or part of the service authentication information as second authentication information, and also transmits the second authentication information to the authentication server via the relay terminal device and the service device,
wherein the authentication server performs a second authentication processing which is a processing for a second authentication using the received second authentication information and the having-been-stored first authentication information, and
wherein the service device receives a result of the second authentication processing from the authentication server, determines whether or not the second authentication has been successfully completed based on the second authentication processing result, and provides the service to the relay terminal device if the second authentication is determined to be successful.

2. The authentication federation system according to claim 1, further comprising a plurality of the relay terminal devices,
wherein the service device stores therein the second authentication processing result,
wherein the mobile terminal transmits information for use in a federated authentication not to the relay terminal device but to a second relay terminal device, receives third authentication information generated by the second relay terminal device using the information for use in a federated authentication received from the mobile terminal, performs a third authentication processing which is a processing for a third authentication using the third authentication information, determines whether or not the third authentication has been successfully completed based on a result of the third authentication processing, reads the stored first authentication information if the third authentication is determined to be successful, and transmits the first authentication information to the service device via the second relay terminal device, and
wherein the service device retrieves the stored second authentication processing result, determines whether or not the second authentication processing result corresponding to the received first authentication information exists, and provides the service to the second relay terminal device if the second authentication processing result corresponding to the received first authentication information exists.

3. The authentication federation system according to claim 1, further comprising a plurality of the relay terminal devices,
wherein the service device stores therein the second authentication processing result,
wherein the mobile terminal transmits information for use in a federated authentication not to the relay terminal device but to a second relay terminal device, receives third authentication information generated by the second relay terminal device using the information for use in a federated authentication received from the mobile terminal, performs a third authentication processing which is a processing for a third authentication using the third authentication information, determines whether or not the third authentication has been successfully completed based on a result of the third authentication processing, reads the stored first authentication information if the third authentication is determined to be successful, and transmits the first authentication information to the service device via the second relay terminal device, and
wherein the service device retrieves the stored second authentication processing result, determines whether or not the second authentication processing result corresponding to the received first authentication information exists, transmits the first authentication information to the authentication server if the second authentication processing result corresponding to the received first authentication information does not exist, receives the second authentication processing result performed by the authentication server, determines whether or not the second authentication has been successfully completed based on the second authentication processing result, and provides a service to the second relay terminal device if the second authentication is determined to be successful.

4. The authentication federation system according to claim 2, wherein the service device receives the first authentication information and a relay terminal device ID of the second relay terminal device, via the second relay terminal device, stores therein the first authentication information and the relay terminal device ID, retrieves already-having-been stored relay terminal device IDs using the newly-received first authentication information and the second relay terminal device ID, determines that the service has currently being provided to the relay terminal device other than the second relay terminal device if an relay terminal device ID corresponding to the first authentication information exists in the already-having-been stored relay terminal device IDs, stops providing the service to the relay terminal device having the relay terminal device ID already-having-been stored and corresponding to the first authentication information, and deletes the relay terminal device ID.

5. The authentication federation system according to claim 3, wherein the service device receives the first authentication information and a relay terminal device ID of the second relay terminal device, via the second relay terminal device, stores therein the first authentication information and the relay terminal device ID, retrieves already-having-been stored relay terminal device IDs using the newly-received first authentication information and the second relay terminal device ID, determines that the service has currently being provided to the relay terminal device other than the second relay terminal device if an relay terminal device ID corresponding to the first authentication information exists in the already-having-been stored relay terminal device IDs, stops providing the service to the relay terminal device having the relay terminal device ID already-having-been stored and corresponding to the first authentication information, and deletes the relay terminal device ID.

6. An authentication federation method used in an authentication federation system, the authentication federation system comprising:
a service device that provides a service via a network;
a relay terminal device that receives the service via the network;
a mobile terminal that is carried and used by a user; and
an authentication server that performs an authentication,
the authentication federation system capable of simplifying a processing of the authentication by the service device and the relay terminal device,
wherein the mobile terminal and the relay terminal device are communicable to each other, and the relay terminal device, the service device, and the authentication server are communicable to each other via the network,
wherein each of the mobile terminal and the authentication server stores therein all or part of authentication information generated in a first authentication processing which is a processing for a first authentication performed between the mobile terminal and the authentication server, as first authentication information,
wherein the relay terminal device receives a result of the first authentication processing from either the mobile terminal or the authentication server, determines whether or not the first authentication has been successfully completed based on the result of the first authentication processing, and transmits service information for use in a service authentication to the mobile phone terminal if the first authentication is determined to be successful,
wherein the mobile terminal generates service authentication information using the first authentication information and the service information, stores therein all or part of the service authentication information as second authentication information, and also transmits the second authentication information to the authentication server via the relay terminal device and the service device,
wherein the authentication server performs a second authentication processing which is a processing for a second authentication using the received second authentication information and the having-been-stored first authentication information, and
wherein the service device receives a result of the second authentication processing from the authentication server, determines whether or not the second authentication has been successfully completed based on the second authentication processing result, and provides the service to the relay terminal device if the second authentication is determined to be successful.

7. The authentication federation method according to claim 6 used in the authentication federation system,
wherein the authentication federation system further comprises a plurality of the relay terminal devices,
wherein the service device stores therein the second authentication processing result,
wherein the mobile terminal transmits information for use in a federated authentication not to the relay terminal device but to a second relay terminal device, receives third authentication information generated by the second relay terminal device using the information for use in a federated authentication received from the mobile terminal, performs a third authentication processing which is a processing for a third authentication using the third authentication information, determines whether or not the third authentication has been successfully completed based on a result of the third authentication processing, reads the stored first authentication information if the third authentication is determined to be successful, and transmits the first authentication information to the service device via the second relay terminal device, and
wherein the service device retrieves the stored second authentication processing result, determines whether or not the second authentication processing result corresponding to the received first authentication information exists, and provides the service to the second relay terminal device if the second authentication processing result corresponding to the received first authentication information exists.

8. The authentication federation method according to claim 6 used in the authentication federation system,
wherein the authentication federation system further comprises a plurality of the relay terminal devices,
wherein the service device stores therein the second authentication processing result,
wherein the mobile terminal transmits information for use in a federated authentication not to the relay terminal device but to a second relay terminal device, receives third authentication information generated by the second relay terminal device using the information for use in a federated authentication received from the mobile terminal, performs a third authentication processing which is a processing for a third authentication using the third authentication information, determines whether or not the third authentication has been successfully completed based on a result of the third authentication processing, reads the stored first authentication information if the third authentication is determined to be successful, and transmits the first authentication information to the service device via the second relay terminal device, and
wherein the service device retrieves the stored second authentication processing result, determines whether or not the second authentication processing result corresponding to the received first authentication information exists, transmits the first authentication information to the authentication server if the second authentication processing result corresponding to the received first authentication information does not exist, receives the second authentication processing result performed by the authentication server, determines whether or not the second authentication has been successfully completed based on the second authentication processing result, and provides a service to the second relay terminal device if the second authentication is determined to be successful.

9. The authentication federation method used in the authentication federation system according to claim 7, wherein the service device receives the first authentication information and a relay terminal device ID of the second relay terminal device, via the second relay terminal device, stores therein the first authentication information and the relay terminal device ID, retrieves already-having-been stored relay terminal device IDs using the newly-received first authentication information and the second relay terminal device ID, determines that the service has currently being provided to the relay terminal device other than the second relay terminal device if an relay terminal device ID corresponding to the first authentication information exists in the already-having-been stored relay terminal device IDs, stops providing the service to the relay terminal device having the relay terminal device ID already-having-been stored and corresponding to the first authentication information, and deletes the relay terminal device ID.

10. The authentication federation method used in the authentication federation system according to claim 8, wherein the service device receives the first authentication information and a relay terminal device ID of the second relay terminal device, via the second relay terminal device, stores therein the first authentication information and the relay terminal device ID, retrieves already-having-been stored relay terminal device IDs using the newly-received first authentication information and the second relay terminal device ID, determines that the service has currently being provided to the relay terminal device other than the second relay terminal device if an relay terminal device ID corresponding to the first authentication information exists in the already-having-been stored relay terminal device IDs, stops providing the service to the relay terminal device having the relay terminal device ID already-having-been stored and corresponding to the first authentication information, and deletes the relay terminal device ID.

11. A mobile terminal used in the authentication federation system according to claim 1, the mobile terminal comprising:
a processing unit; and
a storage unit,
wherein the processing unit generates authentication information for use in a first authentication processing performed between itself and the authentication server, stores all or part of the authentication information in the storage unit as first authentication information, receives service information for use in a service authentication from the relay terminal device, generates service authentication information using the service information and the first authentication information stored in the storage unit, stores all or part of the service authentication information in the storage unit as second authentication information, and transmits the second authentication information to the authentication server via the relay terminal device and the service device.

12. The mobile terminal according to claim 11 used in the authentication federation system according to claim 2,
wherein the processing unit transmits information for use in a federated authentication not to the relay terminal device but to a second relay terminal device, receives third authentication information generated by the second relay terminal device using the information for use in a federated authentication, performs a third authentication processing using the third authentication information, determines whether or not the third authentication has been successfully completed based on a result of the third authentication processing, reads the stored first authentication information if the third authentication is determined to be successful, and transmits the first authentication information to the service device via the second relay terminal device.

13. The mobile terminal according to claim 11 used in the authentication federation system according to claim 3,
wherein the processing unit transmits information for use in a federated authentication not to the relay terminal device but to a second relay terminal device, receives third authentication information generated by the second relay terminal device using the information for use in a federated authentication, performs a third authentication processing using the third authentication information, determines whether or not the third authentication has been successfully completed based on a result of the third authentication processing, reads the stored first authentication information if the third authentication is determined to be successful, and transmits the first authentication information to the service device via the second relay terminal device.

14. A relay terminal device used in the authentication federation system according to claim 1, the relay terminal device comprising:
a processing unit; and
a storage unit,
wherein the processing unit receives the first authentication processing result from either the mobile terminal or the authentication server, determines whether or not the first authentication has been successfully completed based on the first authentication processing result, transmits service information for use in a service authentication to the mobile phone terminal if the first authentication is determined to be successful, transfers the second authentication information transmitted from the mobile terminal to the authentication server via the service device, and receives information on a failure of the authentication transmitted from the service device or receives a service, based on the second authentication processing result in the authentication server.

15. The relay terminal device according to claim 14 used in the authentication federation system according to claim 2,
wherein the second relay terminal device comprises a processing unit and a storage unit, and
wherein the processing unit generates authentication information using the information for use in a federated authentication received from the mobile terminal, transmits all or part of the authentication information as third authentication information to the mobile terminal, receives the transmitted first authentication information based on the result of the third authentication processing performed in the mobile terminal and using the third authentication information, transmits the first authentication information and a relay terminal device ID for identifying itself to the service device, and receives information on a failure of the authentication transmitted from the service device or receives the service, based on a result of a processing concerning the service authentication performed in the service device using the first authentication information and the relay terminal device ID as a result of the second authentication processing using the transmitted first authentication information.

16. The relay terminal device according to claim 14 used in the authentication federation system according to claim 3,
wherein the second relay terminal device comprises a processing unit and a storage unit, and
wherein the processing unit generates authentication information using the information for use in a federated authentication received from the mobile terminal, transmits all or part of the authentication information as third authentication information to the mobile terminal, receives the transmitted first authentication information based on the result of the third authentication processing performed in the mobile terminal and using the third authentication information, transmits the first authentication information and a relay terminal device ID for identifying itself to the service device, and receives information on a failure of the authentication transmitted from the service device or receives the service, based on a result of a processing concerning the service authentication performed in the service device using the first authentication information and the relay terminal device ID as a result of the second authentication processing using the transmitted first authentication information.

17. A service device used in the authentication federation system according to claim 1, the service device comprising:
a processing unit; and
a storage unit that stores the second authentication processing result,
wherein the processing unit receives the second authentication processing result from the authentication server, stores the second authentication processing result in the storage unit, determines whether or not the second authentication has been successfully completed based on the second authentication processing result, and provides the service to the relay terminal device if the second authentication is determined to be successful.

18. The service device according to claim 17 used in the authentication federation system according to claim 2,
wherein the processing unit receives the first authentication information from the relay terminal device, retrieves the second authentication processing result stored in the storage unit using the received first authentication information, and provides the service to the second relay terminal device if the second authentication processing result corresponding to the first authentication information exists.

19. The service device according to claim 17 used in the authentication federation system according to claim 3,
wherein the processing unit receives the first authentication information from the relay terminal device, retrieves the second authentication processing result stored in the storage unit using the received first authentication information, and provides the service to the second relay terminal device if the second authentication processing result corresponding to the first authentication information exists.

20. The service device according to claim 17 used in the authentication federation system according to claim 4,
wherein the processing unit receives the first authentication information and a relay terminal device ID of the second relay terminal device, via the second relay terminal device, stores therein the first authentication information and the relay terminal device ID, retrieves already-having-been stored relay terminal device IDs using the newly-received first authentication information and the second relay terminal device ID, determines that the service has currently being provided to the relay terminal device other than the second relay terminal device if an relay terminal device ID corresponding to the first authentication information exists in the already-having-been stored relay terminal device IDs, stops providing the service to the relay terminal device having the relay terminal device ID already-having-been stored and corresponding to the first authentication information, and deletes the relay terminal device ID.
